(19) United States
(12) Patent Application Publication
(10) Pub. No.: US 2023/0294747 A1
(43) Pub. Date: Sep. 21, 2023

(54) SYSTEMS AND METHODS FOR CONTROLLED TRAVERSAL OF PHASE BREAKS

(71) Applicant: Transportation IP Holdings, LLC, Norwalk, CT (US)

(72) Inventors: Stuart J. Barr, Cedar Rapids, IA (US); Karen A. Shaw, Cedar Rapids, IA (US); Keith Edward Smith, Cedar Rapids, IA (US)

(21) Appl. No.: 18/322,786

(22) Filed: May 24, 2023

Related U.S. Application Data
(63) Continuation-in-part of application No. 16/723,648, filed on Dec. 20, 2019, now Pat. No. 11,701,970.

(51) Int. Cl. B61L 3/00; B60L 5/00

(52) U.S. Cl. CPC B61L 3/006; B60L 5/00

(57) ABSTRACT

A control system can include a controller that may obtain a location of a phase break along a route. The controller can monitor locations of a vehicle and determine when the vehicle will reach the phase break location. The system also may include a switch proximate to a collector device of the vehicle and/or an actuator that moves the collector device relative to a conductive pathway. The conductive pathway may operate to supply electrical power to the vehicle. The controller can actuate a switch, an actuator, or both the switch and the actuator, and (upon activation) can change a source of power for one or more loads for propulsion of the vehicle through the location of the phase break along the route.

### CROSS-REFERENCE TO RELATED APPLICATIONS

This application is a continuation-in-part of U.S. patent application Ser. No. 16/723,648 (filed 20 Dec. 2019), the entire disclosure of which is incorporated herein by reference.

### BACKGROUND

### Technical Field

The subject matter described relates to systems and methods that control movement of a vehicle.

### Discussion of Art

Certain vehicles travel along routes and receive power from sources (e.g., catenary lines) disposed along the route. Practical limitations on the length of such sources may require a vehicle to switch from one source of power to another (e.g., from a first catenary source to a second catenary source). However, the sources of power may be at different phases and/or voltage levels, with an interruption in the power supply interposed between the sources, requiring the vehicle to disconnect from the power source while traversing the interruption in the power supply. Various activities may be performed to prepare the vehicle for traversing the interruption. However, current approaches, for example, may not provide operators with a desired amount of information regarding upcoming interruptions in power. It may be desirable to have a system and method that differs from those that are currently available.

### BRIEF DESCRIPTION

In one example, a control system is provided that can include a controller that may obtain a location of a phase break along a route to be traversed by a vehicle. The controller can monitor a location of the vehicle and determine an arrival time of the vehicle at the location of the phase break using the location of the phase break and the location of the vehicle. The system also may include a switch and/or an actuator. The switch can be proximate to a collector device of the vehicle. The actuator can move the collector device in at least one direction relative to a conductive pathway. The conductive pathway may operate to supply electrical power to the vehicle. The controller can actuate the switch, the actuator, or both the switch and the actuator, and (upon activation) can change a source of power for one or more loads for propulsion of the vehicle through the location of the phase break along the route.

In another example, a method for controlling a vehicle is provided and can include obtaining a location of a phase break along a route to be traversed by the vehicle, obtaining a location of the vehicle, determining an arrival time of the vehicle at the location of the phase break based at least in part on the location of the phase break and the location of the vehicle, and controlling a responsive device to change a source of power for one or more loads of the vehicle for travel of the vehicle through the location of the phase break along the route.

In another example, another control system is provided that may include a collector device that can be onboard a vehicle and can move relative to a conductive pathway extending along a route. The collector device may receive electric energy from the conductive pathway to power one or more loads of the vehicle during movement of the vehicle along the route. The control system can include a controller that may monitor locations of the vehicle and determine whether the vehicle is approaching a phase break of the conductive pathway. The controller may change a source of power for the one or more loads from the conductive pathway for travel of the vehicle through the phase break.

### BRIEF DESCRIPTION OF THE DRAWINGS

The inventive subject matter may be understood from reading the following description of non-limiting embodiments, with reference to the attached drawings, wherein below:

FIG. 1 illustrates one example of a network including a phase break;

FIG. 2 provides a schematic block diagram of example aspects of the network of FIG. 1;

FIG. 3 provides a schematic block diagram of aspects of the network of FIG. 1 disposed on a vehicle;

FIG. 4 illustrates a flowchart of one example of a method for controlling a vehicle traversing a route including a phase break; and

FIG. 5 illustrates one example of a power control system.

### DETAILED DESCRIPTION

Embodiments of the subject matter described herein relate to systems and methods that may determine when a vehicle will approach or arrive at a phase break (e.g., within a determined distance or time), and provide prompts and/or control signals to the vehicle. As used herein, a phase break may be understood as an electrically isolated section of route (e.g., an overhead power cable or electrified rail) used to power vehicles (e.g., vehicles using a sliding pantograph) touching the portion of the route (e.g., overhead power cable), with the phase break used to separate two sections (e.g. sections of catenary) with different phases and/or voltage. For example, various systems and/or methods disclosed herein control a signal output to a vehicle to indicate when the vehicle is entering and leaving a phase break. In some embodiments, the phase break location is identified as single location in the center of the phase break (e.g., from a track database such as a positive train control track database). The phase break may be an interface or location between the different sections of the conductive pathways or between a route section having a conductive pathway and another route section not having the conductive pathway. While some embodiments utilize an alternating current overhead cable or catenary, other embodiments may utilize a different source of power, such as a direct current system providing power through a 3^{rd} rail, or through 3^{rd} and 4^{th} rails (e.g., power and return rails). While direct current systems do not have phase change issues that may be present in alternating current systems, there are still breaks along routes for such direct current systems to accommodate relatively frequent substations to address power loss in such systems. Optionally, a phase break may be a section or segment of a route that does not have a conductive pathway (that may be between other sections or segments having the conductive pathway, which is downstream or upstream of a section or segment having the conductive pathway, or the like).

While example embodiments may be discussed in connection with rail vehicle systems, not all embodiments described herein are limited to rail vehicle systems and/or positive train control systems. For example, one or more embodiments of the systems and methods described herein can be used in connection with other types of vehicles receiving power as they travel along a route, such as automobiles, trucks, buses, mining vehicles, marine vessels, or the like. The systems and methods, for example, can notify these other types of vehicles of upcoming breaks or disturbances in power supplies.

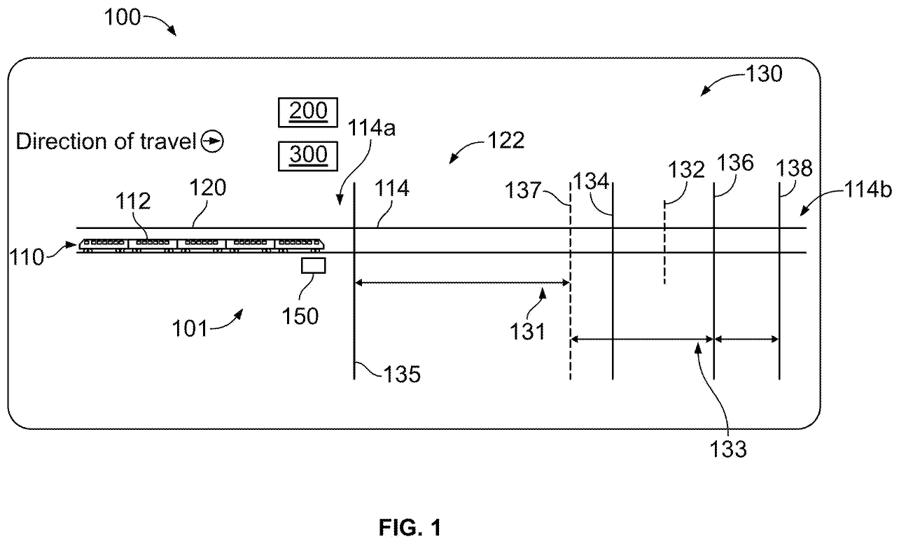

FIG. 1 illustrates an example network 100 that includes a vehicle 110, an office system 200, and a monitoring system 300. Generally the vehicle 110 traverses a route 101 of the network 100, and can receive power from a supply pathway 114 via a collector device 112. The collector device can represent a pantograph, a conductive shoe or brush, or another device that receives electric energy from the conductive pathway via conduction or induction of the energy between the conductive pathway and the collector device. The supply pathway can represent a catenary, an electrified rail, another conductive pathway, an inductive body, or the like, which conveys electric energy (e.g., alternating current or direct current) to the vehicle and/or receives the electric energy from the vehicle. A phase break 130 may be disposed along the route along a path to be traversed by the vehicle. A single vehicle is shown traversing a single route of the network in FIG. 1 for ease and clarity of illustration, however multiple vehicles may traverse multiple routes of the network. The office system is located off-board the vehicle and can provide information and/or commands to the vehicle (as well as other vehicles) traversing various routes of the network. The monitoring system can help control the vehicle as the vehicle approaches the phase break. The monitoring system may be disposed on-board the vehicle in some embodiments, and off-board the vehicle in other embodiments. Further, in some embodiments, some aspects of the monitoring system may be disposed on-board the vehicle while other aspects are disposed off-board the vehicle.

Generally, as used herein, a catenary may be understood as a power cable that is strung over tracks to provide power to a vehicle, such as a train, through a pantograph (e.g., the collector device). A pantograph as used herein may be understood as an apparatus attached to a vehicle (e.g., to the roof of a train car or locomotive) to reach the catenary line and draw current from the catenary line. Not all embodiments of the inventive subject matter are limited to catenaries and pantographs, however, unless expressly and explicitly limited to use of a catenary and a pantograph.

As the vehicle traverses the route, there may be practical limitations on the length of a given section of the supply pathway. Accordingly, the vehicle may travel past the range of a first section of the supply pathway and into the range of a second section of the supply pathway from which the vehicle will receive power. However, adjacent sections of the supply pathway may provide power at different phases. Accordingly, a phase break may be placed between the sections to isolate the sections at different phases from each other. In the illustrated example, the phase break is disposed between a first section 114a and a second section 114b of the supply pathway, with the first section associated with a first power source, and the secondary section associated with a second power source that provides power at a different phase and/or voltage from the first power source. The isolated section, for example, may be run to ground. Optionally, the phase break may occur due to sections of the route that do not have a supply pathway, sections where the supply pathway is inoperable or unreachable by the collector device of the vehicle, or the like. As used herein, a phase break can represent a section of a route over or within which the collector device is unable to obtain power from the supply pathway and/or there is a change in the power provided via the supply pathway.

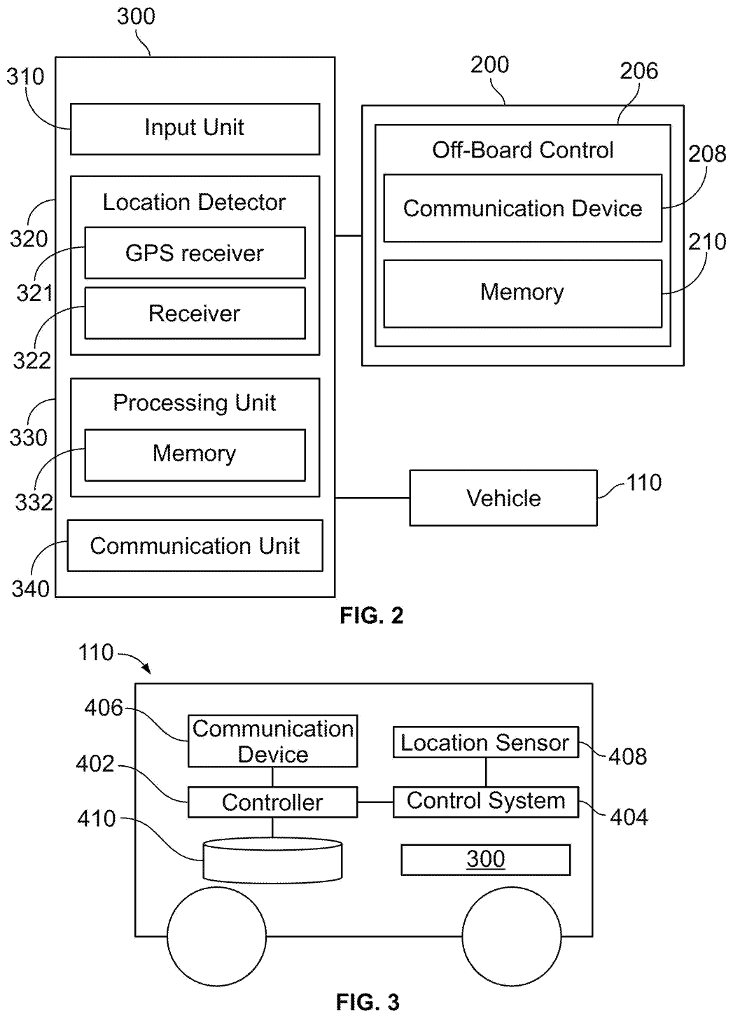

FIG. 2 provides a schematic block diagram of aspects of the network according to various embodiments. As seen in FIG. 2, the monitoring system can include a phase break input unit 310, a location detector 320, and a processing unit 330. Generally, the monitoring system can determine when or whether the vehicle is approaching the phase break and causes or helps cause initiation of various control activities to be performed on or by the vehicle in preparation for traversing the phase break. The monitoring system may acquire information regarding the location of the vehicle and the phase break relative to each other and may determine when it is appropriate to begin preparation of the vehicle for the phase break. The location of the vehicle may be obtained or provided by wayside devices or sensors, a global navigation satellite system (GNSS) receiver onboard the vehicle (such as a global positioning system (GPS) receiver), or the like, and communicated to the system. The location of the phase break may be stored in a memory accessible to or included in the system.

The monitoring system in the example embodiment is configured to communicate with the office system. The office system in various embodiments may include an off-board control system 206, which may be referred to as a vehicle management control system or an off-board control system as the system office (and control system) may be off-board the vehicle. The off-board control system can represent hardware circuitry that includes and/or is connected with one or more processors that perform the operations of the off-board control system. The off-board control system can include or be connected with a communication device 208 that is configured to communicate with the monitoring system and/or the vehicle 110. The communication device can represent transceiving circuitry, such as one or more antennas, modems, receivers, transmitters, or the like.

The off-board control system in various embodiments can be, include, or be a part of a back-office server of a positive train control system. Alternatively, the off-board control system can be another system that monitors movements of the vehicles to ensure safe travel of the vehicles. For example, the off-board control system can be configured as, form a part of, or be associated with a dispatch facility, a scheduling facility, or the like. The off-board control system can include a tangible and non-transitory computer-readable storage medium (e.g., a memory 210) that stores locations of the phase breaks, and/or other information.

The phase break input can obtain phase break location information. The phase break input may include one or more components configured to receive a manual input providing the phase break location (e.g., keyboard, scanner, or the like), and/or include one or more components configured to receive communication signals including the phase break location (e.g., wireless receiver). The phase break location information indicates the location of a phase break (e.g., phase break 130) along a route (e.g., route 101) to be traversed by the vehicle. The phase break information can be obtained before the vehicle arrives at the phase break, with the phase break information utilized to help prepare the vehicle for traversing the phase break. The phase break location information may include information regarding plural phase breaks to be encountered by the vehicle, of which phase break 130 provides an example. The phase break information may be obtained from information that is determined or known ahead of time. For example, each phase break along a given length or section of route may be stored in a database and/or as locations along a map (e.g., by the office system) which are provided via the phase break input before the vehicle approaches the phase break. In various embodiments, the phase break input information may be provided autonomously or automatically. For example, the vehicle may traverse through different territories (e.g., different territories of a positive train control system), with each territory having a given number of phase breaks at known locations disposed within the territory. As the vehicle enters a given territory, the phase break information may be acquired via the phase break input. For example, responsive to a change in territory by the vehicle, the phase break input unit may obtain the phase break location information from the office system or other office system disposed off-board of the vehicle. In various embodiments, the phase break input unit may be configured (e.g., programmed or instructed) to obtain locations of phase breaks within a given territory when the vehicle enters that particular territory. Once obtained, the phase break information may be stored (e.g., in memory 332) and used by the monitoring system as discussed herein. In one embodiment, the phase break input unit may monitor current, and particularly monitor for a drop in current. The current drop may precede a subsequent voltage drop by a measure of time. In this way, a phase break may be detected just prior to a voltage drop and some responsive measures may be taken by the controller.

The system and method may manage the phase breaks by controlling operations of other vehicles that have not yet encountered a given phase break location. For example, the system and method identify a location associated with a phase break, and then may communicate that location of the phase break to one or more other vehicles and instruct the other vehicles to take proactive measures, such as to either accommodate the voltage drop along the phase break or to avoid the phase break. Furthermore, the system and method may manage the phase breaks by determining a potential cause of a phase break and initiating at least one remedial action, based on the potential cause, to alleviate or correct the phase breaks. For example, the system and method may aggregate gap characteristics, which is statistical data, collected from plural different vehicles and/or plural different trips of a vehicle. The gap characteristics may be collected from an entire fleet of vehicles. The gap characteristics may be analyzed by a controller device to predict the potential cause of a phase break and/or generate a recommendation to a facility operator, vehicle operator, and/or dispatch personnel about how to correct the phase break. The gap characteristics may be used to determine whether the phase break is localized to a specific vehicle, a specific collector device onboard of a vehicle, a specific section of the route, or a specific section of the conductive pathway extending along the route. The at least one remedial action may include directing maintenance, inspection, and/or repair of the vehicle that encountered the phase break (e.g., the collector device and/or suspension of the vehicle), the conductive pathway, and/or the route traveled by the vehicle.

One embodiment may provide a reliability improvement by reducing failure modes attributable to arcing electric current. Another technical effect of the embodiments described herein may reduce the number of phase breaks encountered by vehicles in a vehicle network by warning other vehicles about the locations of identified gaps to avoid the gaps and/or by initiating inspection and repair of specific vehicles, collector devices, route segments, and/or conductive pathway segments to eliminate the identified gaps. At least one technical effect of the embodiments described herein reduces an amount of voltage overshoot upon conductive reconnection of the collection device of the vehicle to the conductive pathway exiting a gap, which enables the use of lower cost power electronics onboard the vehicle and/or reduces the risk of damage to the vehicle power electronics, relative to systems that experience greater voltage overshoots.

In one embodiment, a phase break may be caused by physical separation of the collector device from the conductive pathway. For example, one of the wheels or wheelsets of the vehicle enters a depression in the route. The depression may be a rut, a pothole, or the like. The depression may be caused by erosion, degradation of the route, damage inflicted on the route, and/or the like. In an example, the route may include an unpaved roadbed, and the depression may be caused by degradation in the roadbed. As the vehicle traverses through the depression, the front end of the vehicle lowers relative to the rear end, at least temporarily. The bowing of the front end may pull the collector device downward away from the conductive pathway. The collector device may at least temporarily mechanically separate from the conductive pathway creating a phase break. The collector device may reestablish the conductive connection to the conductive pathway upon the wheel or wheelset exiting the depression and/or a spring or other biasing member of the collector device lifting the collector contacts higher to reach the conductive pathway.

The location detector can obtain vehicle location information. The vehicle location information indicates at least one of a location of the vehicle and/or the movement of the vehicle. Vehicle location information in various embodiments includes, for example, one or more of geographical location of the vehicle, identification of a route on which the vehicle is disposed (or will be disposed), identification of switch position for a switch that has been encountered or will be encountered by the vehicle, or a speed of the vehicle. One or more location detectors may be utilized in various embodiments, and that location detector(s) may be disposed on-board and/or off-board the vehicle. For example, a speedometer disposed on-board the vehicle may be used to determine the speed of the vehicle. As another example, the location detector in various embodiments includes one or more sensors located on-board the vehicle and configured to utilize signals from a satellite such as a GNSS or other satellite positioning system. In some embodiments, the location detector includes a GNSS receiver 321 disposed on-board the vehicle. As another example, the location detector may include a receiver 322 that is configured to receive switch information from a wayside device 150 that is disposed along the route, such as a transponder, camera, or the like, that can identify the vehicle and report passage of the vehicle by the wayside device (which has a known or reported location).

The processing unit can be operably coupled to the phase break input unit and the location detector and can acquire information from the phase break input unit and the location detector. The processing unit is shown as a single unit; however, in various embodiments the processing unit may be distributed among or include more than one physical unit and may be understood as representing one or more processors. The processing unit represents hardware circuitry that includes and/or is connected with one or more processors (e.g., one or more microprocessors, integrated circuits, microcontrollers, field programmable gate arrays, etc.) that perform operations described herein. The processing unit can acquire information in a tangible and non-transitory computer-readable storage medium (e.g., memory 332). Additionally or alternatively, instructions for causing the processing unit to perform one or more tasks discussed herein may be stored in a tangible and non-transitory computer-readable storage medium (e.g., memory 332 in FIG. 2).

In the illustrated example, the processing unit can obtain the phase break location information (e.g., via phase break input unit), and can obtain the vehicle location information (e.g., via one or more location detectors). The processing unit may determine an estimated arrival time of the vehicle at the phase break using the phase break location information and the vehicle location information. For example, the processing unit may use a location of the vehicle that is estimated or measured using the vehicle location information, a speed of the vehicle that is estimated or measured using the vehicle location information, and a known location of the phase break from the phase break information to determine a distance between the vehicle and the phase break, as well as the rate at which the vehicle is approaching the phase break. For a territory with multiple phase breaks, the processing unit may identify a particular phase break as the next phase break to be encountered by the vehicle and use that particular phase break's location in determining the estimated time of arrival. The speed of the vehicle, for example, may be determined using multiple determined positions over a known change in time, or as another example, a speedometer disposed on-board the vehicle.

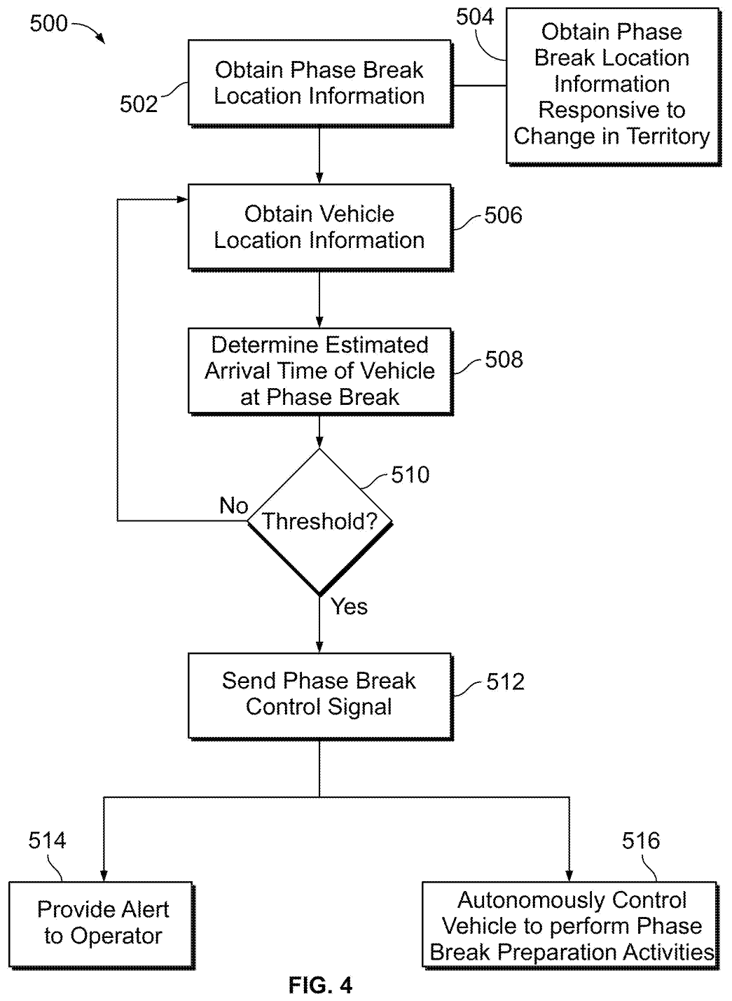

With the estimated time of arrival determined, the processing unit can send a phase break control signal to a vehicle control system (e.g., the vehicle control system 404 shown in FIG. 4) of the vehicle responsive to the estimated arrival time satisfying a threshold. For example, the threshold may be a determined amount of time apportioned for performing activities to prepare the vehicle for arrival at the phase break and/or traversal of the phase break. The threshold may also include a buffer time amount to provide a safety factor for performance of the activities. As the vehicle travels along the route, the processing unit may periodically or otherwise repeatedly determine the current position of the vehicle with respect to the phase break along with the speed of the vehicle, determine a current or updated estimated time of arrival, and compare the most recent estimated time of arrival with the threshold. When the threshold is satisfied (e.g., the estimated time of arrival is equal to or less than the threshold), the phase break control signal can be sent. For example, the state of one or more control signals may be altered responsive to satisfaction of the threshold. Alternatively, the processing unit may send the control signal without comparing the estimated arrival time to a threshold. That is, the processing unit may send the control signal once the phase break is identified and/or approach of the vehicle to the phase break is identified without comparing an estimated arrival time to a threshold.

In some embodiments, the phase break control signal is configured to provide an alert to an operator of the vehicle. For example, the phase break control signal may cause a prompt to appear on a display of the vehicle and may include a list of activities to be performed by the operator to prepare for the phase break. The prompt may provide a message indicating the approaching phase break location. Alternatively, the prompt may provide a message when a leading edge of the vehicle arrives a set distance before the phase break. Additionally, or alternatively, the control signal may be configured to autonomously control the vehicle to perform one or more phase break preparation activities. For example, if the operator has not responded to a previous prompt or it is otherwise determined that phase break preparation should begin, the processing unit may send a control signal to the vehicle causing autonomous performance of one or more phase break activities. In various embodiments, when, while, or responsive to the state of the control signal changing, the control signal may cause the vehicle to take one or more actions (e.g., open catenary circuit breaker, drop the pantograph from the catenary to remove power, engage dynamic braking as a temporary power source, decrease or otherwise change vehicle speed, connect and/or draw voltage from one or more energy storage devices to power loads, etc.) in preparation for arriving and departing the phase break location.

Generally, phase break activities can be activities to be performed before the vehicle encounters the phase break. For example, in various embodiments, phase break preparation activities include placing the vehicle in neutral, opening a catenary circuit breaker, stopping the provision of power from the catenary to vehicle (e.g., by disengaging the pantograph from the catenary), engaging dynamic breaking (e.g., to provide temporary power), connecting energy power source(s) (e.g., batteries, fuel cells, etc.) to provide temporary power through the phase break, and so on. Different activities may be performed at various distances from the phase break in a designated sequence. Accordingly, plural control signals or states of a control signal may be utilized. Further, after passing the phase break, additional steps may be taken (e.g., displaying that the phase break has been passed, raising the pantograph to engage the catenary of the second catenary portion, etc.).

With reference to FIG. 1, various activities may be performed based on location of the vehicle with respect to the phase break. In the illustrated example, for instance, various boundaries with respect to the phase break are illustrated: an entry boundary 135, a signal point 137, a phase break beginning 134, a phase break center 130, a phase break end 136, and an exit boundary 138. In the illustrated embodiment, as the vehicle (e.g., a leading edge of the vehicle) passes the entry boundary (e.g., based on the estimated arrival time), a phase break information prompt can be displayed to an operator of the vehicle responsive to a control signal from the monitoring system. In the depicted example, the prompt is displayed until the signal point at which point a control signal is driven to a high state, with a power cut out prompt displayed. If the prompt does not result in the cut out of power and/or other appropriate phase break preparation activities occurring, the monitoring system may send a control signal causing the autonomous performance of one or more phase break preparation activities (e.g., placing the vehicle in neutral, moving the collector device to disengage from the first supply pathway portion). The prompt showing power cut out can be displayed as the vehicle passes the phase break beginning and phase break center (where the signal may be released) until the vehicle reaches or passes the phase break end, at which point a prompt showing the restoration of power may be displayed. If power is not restored within a desired time of passing the phase break, the monitoring system may send one or more control signals to restore power (e.g., move the collector device to engage the second supply pathway portion). Once the vehicle is past the exit boundary, the monitoring system may analyze the phase break location information to identify additional upcoming phase breaks, and optionally determine an estimated arrival time at the next phase break.

The depicted monitoring system also may include a communication device 340. The communication device may include one or more components (e.g., receiver, transceiver) configured to communicate or obtain information from off-board sources such as the office system or wayside device. While the communication device 340 is shown as a single distinct block, in various embodiments the communication device may work with or form a part of aspects of the monitoring system (or be formed from one or more aspects of the monitoring system), such as the phase break input unit. For example, the communication device may receive the phase break input location from the office system and provide the phase break location to the processing unit. Further, in some embodiments, the monitoring system may communicate with one or more off-board systems (e.g., office systems) to inform appropriate office systems when or whether the vehicle enters a territory associated with a particular office system (e.g., to obtain phase break information from the appropriate office system). Additionally or alternatively, the communication unit may work with or form a part of a receiver 322 for receiving location information (e.g., from the wayside device). Accordingly, in various embodiments, one or more aspects of the receiver and/or phase break input unit may be incorporated into or cooperate with the communication device. Further, the communication unit may communicate with the vehicle (e.g., in embodiments where the monitoring system or aspects thereof are disposed off-board the vehicle). For example, the monitoring system may send control signals to the vehicle via the communication unit.

The monitoring system (or aspects thereof) is configured to be disposed on the vehicle. For example, in some embodiments, the phase break unit and the location detector can be disposed on the vehicle. FIG. 3 illustrates an example embodiment in which the phase break input unit and location detector are disposed on the vehicle. In the illustrated example, the entire monitoring system is disposed on the vehicle. Optionally, one or more components of the monitoring system may be off-board the vehicle and one or more other components of the monitoring system may be onboard the vehicle. Or the entire monitoring system may be off-board the vehicle.

The vehicle can include a controller 402 that represents one or more processors that control movement and other operations of the vehicle. This controller can be referred to as a vehicle controller. The vehicle controller can represent an engine control unit, an onboard navigation system, or the like, which can control a propulsion system (e.g., one or more engines, motors, etc.) and/or a braking system (e.g., one or more friction brakes, air brakes, regenerative brakes, etc.) to control movement of the vehicle.

The vehicle optionally includes the vehicle control system 404 that communicates with the monitoring system for receiving control signals (e.g., signal sent, or states of signals changed responsive to satisfaction of a threshold for arrival at an upcoming phase break). The control signals can be received by the vehicle controller and/or vehicle control system via a communication device. This communication device (as well as other communication units discussed herein) can include an antenna and wireless transceiving circuitry that wirelessly communicates signals with other communication devices described herein. A tangible and non-transitory computer-readable storage medium (e.g., a memory 410) of the vehicle may store acquired information (e.g., phase break locations, vehicle locations) and/or instructions for causing performance of one or more tasks by the vehicle controller. The vehicle may include a location sensor 408 that determines locations and/or headings of the vehicles. The location sensor can represent a GNSS receiver, a wireless triangulation system, a dead reckoning system, inertial sensors, or the like, which determines locations, speeds, and/or headings of the vehicle. The locations, speeds, and/or headings of the vehicles can be determined by the location sensors and communicated to the monitoring system (e.g., to provide the location information). One or more aspects of the vehicle and monitoring system may be shared, such as communication devices for communicating with the off-board office system, or, as another example, the location sensor may provide an example of the location detector in various embodiments.

FIG. 4 illustrates a flowchart of one example of a method 500 for controlling a vehicle traversing a route having one or more phase breaks. The method, for example, may employ or be performed by structures or aspects of various embodiments (e.g., systems and/or methods and/or process flows) discussed herein. In various embodiments, certain steps may be omitted or added, certain steps may be combined, certain steps may be performed concurrently, certain steps may be split into multiple steps, certain steps may be performed in a different order, or certain steps or series of steps may be re-performed in an iterative fashion. In various embodiments, portions, aspects, and/or variations of the method may be able to be used as one or more algorithms to direct hardware (e.g., one or more aspects of the processing unit) to perform one or more operations described herein.

At step 502, phase break location information is obtained. The phase break location information may indicate the location of a phase break along a route to be traversed by a vehicle. The phase break location may be obtained before the vehicle arrives at the phase break or once the vehicle reaches the phase break. For example, the phase break location may be obtained when the vehicle enters a territory having one or more phase breaks. In the illustrated example, at step 504, the phase break location information is obtained from an office system (e.g., a dispatching system, or a back-office system, for example, for positive train control) that is disposed off-board the vehicle responsive to a change in territory of the vehicle.

At step 506, vehicle location information is obtained. For example, the vehicle location information may be obtained via one or more vehicle location detectors. In some embodiments, the location information includes information obtained via a GNSS receiver. For example, locations of the vehicle may be detected at different times as the vehicle moves, and the method may include estimating the speed of the vehicle using the locations that were detected at different times. Alternatively or additionally, obtaining the location information in various embodiments includes receiving switch information from a wayside device that is disposed along the route, and determining the location of the vehicle using the switch information. The vehicle location information indicates at least one of location of the vehicle or movement of the vehicle. For example, the vehicle location information may include a geographic position of the vehicle, a speed of the vehicle, and/or information identifying a track or other route on which the vehicle is disposed.

At step 508, an estimated arrival time of the vehicle at the phase break can be determined. The estimated arrival time may be determined using the phase break location information and the vehicle location information. For example, a distance between the phase break and the vehicle may be determined, and an estimated speed of the vehicle used to estimate the time for traversing the determined distance.

At step 510, it is determined whether the estimated arrival time satisfies a threshold (e.g., is equal to or less a determined amount of time corresponding to the time required to perform phase break preparation activities). For example, the threshold may be set to provide an operator or crew with sufficient time to perform phase break preparation activities along with an amount of additional time. If it is determined that the threshold is not satisfied at step 510, the method may return to step 506 to update vehicle location information. If it is determined at step 510 that the threshold is satisfied, then, at step 512, a phase break control signal can be sent to the vehicle control system of the vehicle responsive to the estimated arrival time satisfying the threshold. For example, the state of a control signal sent to the vehicle may change. The phase break control signal may cause a prompt to be displayed to one or more operators of the vehicle, and/or cause a control action to be performed on or by the vehicle.

For example, at step 514, the control signal can be received on-board the vehicle, and an alert is provided to an operator of the vehicle responsive to receiving the control signal. The alert, for example, may provide a notification of an upcoming phase break, and/or list phase break preparation activities to be performed.

As another example, at step 516, the control signal may be received on-board the vehicle, and the vehicle is autonomously controlled to perform one or more phase break preparation activities responsive to receiving the control signal. For example, if a determined time after a prompt to perform a required phase break preparation activity (or activities) has expired and the activities not performed, the activity (or activities) may be autonomously performed by the vehicle control system of the vehicle responsive to receiving a control signal sent at step 512.

In one example, a control or monitoring system may include a phase break input unit, one or more vehicle location detectors, and one or more processors. The phase break input unit can obtain phase break location information indicating a location of a phase break along a route to be traversed by a vehicle. The phase break location information may be obtained before the vehicle arrives at the phase break. The one or more vehicle location detectors can obtain vehicle location information indicating at least one of location of the vehicle and/or movement of the vehicle. The one or more processors may determine an estimated arrival time of the vehicle at the phase break using the phase break location information and the vehicle location information and send a phase break control signal to a vehicle control system of the vehicle responsive to the estimated arrival time satisfying a threshold.

The phase break input unit and the vehicle location detector(s) can be onboard the vehicle. For example, in some embodiments, the phase break input unit may obtain the phase break location information from an office system disposed off-board the vehicle responsive to a change in territory of the vehicle. The vehicle location detector(s) may include a GNSS receiver, such as a GPS receiver. The vehicle location detector(s) may include a receiver configured to receive switch information from a wayside device disposed along the route. The control signal can provide an alert to an operator of the vehicle. Alternatively or additionally, the control signal can autonomously control the vehicle to perform one or more phase break preparation activities.

In another example, a method may include obtaining phase break location information indicating a location of a phase break along a route to be traversed by a vehicle. The phase break location information can be obtained before the vehicle arrives at the phase break. The method may include obtaining, via one or more vehicle location detectors, vehicle location information indicating at least one of location of the vehicle or movement of the vehicle. Further, the method may include determining an estimated arrival time of the vehicle at the phase break using the phase break location information and the vehicle location information. Also, the method can include sending a phase break control signal to a vehicle control system of the vehicle responsive to the estimated arrival time satisfying a threshold.

The method may include obtaining the phase break location information from an office system disposed off-board the vehicle responsive to a change in territory of the vehicle. The method can include obtaining the location information via a GNSS receiver. For example, the method may include detecting locations of the vehicle at different times and estimating the speed of the vehicle using the locations detected at different times. The method may include receiving switch information from a wayside device disposed along the route and determining the location of the vehicle using the switch information.

The method may include receiving the control signal on-board the vehicle and providing an alert to an operator of the vehicle responsive to receiving the control signal. The method can include receiving the control signal on-board the vehicle, and autonomously controlling the vehicle to perform one or more phase break preparation activities responsive to receiving the control signal.

In another example, a tangible and non-transitory computer readable media can include instructions that control or direct one or more processors to obtain phase break location information indicating a location of a phase break along a route to be traversed by a vehicle. The phase break location information can be obtained before the vehicle arrives at the phase break. The instructions can control or direct the processor(s) to obtain, via one or more vehicle location detectors, vehicle location information indicating at least one of location of the vehicle or movement of the vehicle. The instructions can control or direct the processor(s) to determine an estimated arrival time of the vehicle at the phase break using the phase break location information and the vehicle location information. The instructions can control or direct the processor(s) to send a phase break control signal to a vehicle control system of the vehicle responsive to the estimated arrival time satisfying a threshold.

The instructions can control or direct the processor(s) to control the one or more processors to obtain the phase break location information from an office system disposed off-board the vehicle responsive to a change in territory of the vehicle. The instructions can control or direct the processor(s) to control the one or more processors to obtain the location information via a GNSS receiver. For example, The instructions can control or direct the processor(s) to control the one or more processors to detect locations of the vehicle at different times and estimate a speed of the vehicle using the locations detected at different times. The control signal can provide an alert to an operator of the vehicle. Alternatively or additionally, the control signal can autonomously control the vehicle to perform one or more phase break preparation activities.

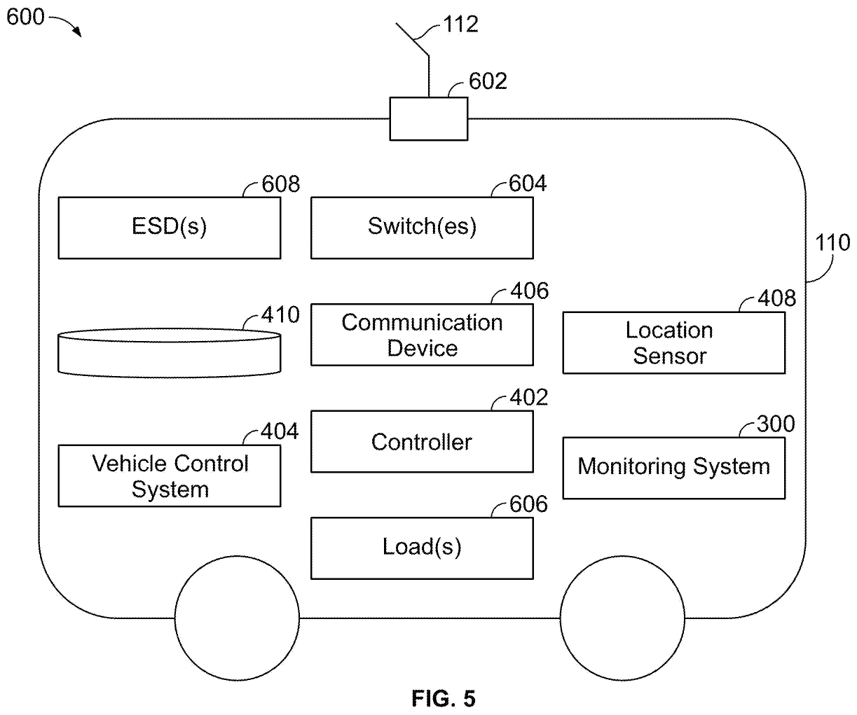

FIG. 5 illustrates one example of a power control system 600. The power control system may be used to control operation of the vehicle during approach to, traversal through, and/or exit from phase breaks along routes. The power control system may be entirely disposed onboard one vehicle (as shown in FIG. 5) or may have one or more components disposed onboard another vehicle and/or not onboard any vehicle (with the components communicating via wireless and/or wired connections).

The power control system may include the communication device, the controller, the location sensor, the memory, the monitoring system, and/or the vehicle control system described above. The power control system may be connected with and able to control the collector device described above. For example, the power control system may include (or does not include but may control) one or more actuators 602 that can move the collector device into and/or out of engagement with the conductive pathway or close proximity with the conductive pathway to conduction of electric energy (e.g., alternating current or direct current) or passage of this electric energy between the conductive pathway and the collector device. Examples of actuators can include motors, pneumatic devices, or the like.

The vehicle may include one or more switches 604 between the collector device and the components that are powered by energy received via the collector device. These switches can alternate between open and closed positions to open or close, respectively, a connection between the collector device and loads 606 of the vehicle. For example, the switch(es) can open to disconnect the loads of the vehicle from the collector device and can close to connect the loads of the vehicle with the collector device. Collectively, the switch and/or actuator may be referred to as a responsive device.

The vehicle may include one or more onboard energy storage devices, or EDS(s), 608. These energy storage devices can include batteries, super or ultra capacitors, or the like, that can store electric energy (e.g., received via the collector device, a connector to an off-board charging system, dynamic braking, or the like) and discharge this electric energy to one or more components of the vehicle to power the components (e.g., traction motors, actuators, auxiliary loads, or the like).

In addition to or in place of the other operations described herein, the power control system and/or the vehicle control system may control the energy storage devices to power the loads of the vehicle through the phase breaks. For example, prior to or upon reaching a phase break, the power and/or vehicle control system may activate or otherwise control the energy storage devices to supply electric energy to the loads for powering the loads during travel through the phase break.

The periods of transition entering and/or exiting a phase break may cause abrupt changes in the supply or conduction of electric energy to the loads. These abrupt changes may damage one or more of the loads. To prevent this damage, the power and/or vehicle control systems may open the switch(es) and/or deactivate one or more loads prior to reaching the phase break and then close the switch(es) and/or activate the load(s) either after the switch or transition from obtaining energy from the collector device to obtaining the energy from the energy storage devices is complete. For example, the control system may open a switch to disconnect the collector device from loads of the vehicle prior to reaching the start of a phase break. The control system may keep the switch open during travel through the phase break with the loads of the vehicle being powered by the energy storage devices of the vehicle. After passing through the phase break, the control system may close the switch so that the loads are again connected with the collector device. This can allow for the loads to be powered again by the energy received via the collector device.

As another example, the control system may control the actuator to move the collector device away from the conductive pathway to disconnect the collector device and the loads of the vehicle from the conductive pathway prior to reaching the start of a phase break. The control system may keep the collector device disconnected (e.g., either conductively or inductively) from the conductive pathway during travel through the phase break with the loads of the vehicle being powered by the energy storage devices of the vehicle. After passing through the phase break, the control system may control the actuator to move the collector device toward the conductive pathway so that the collector device is able to receive electric energy from the conductive pathway. This can allow for the loads to be powered again by the energy received via the collector device. Optionally, the control system may control both the actuator and the switch(es) through the transitions of entering and leaving the phase breaks. These operations of switching to powering the loads via the energy storage devices during travel in phase breaks may be the operations performed at step 516 in the method 500 shown in FIG. 4.

In one embodiment, the control system and/or monitoring system may have a local data collection system (e.g., the memory 410 and/or controller 402) deployed that may use machine learning to enable derivation-based learning outcomes. The controller may learn from and make decisions on a set of data (including data provided by various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for vehicle performance and behavior analytics, and the like.

In one embodiment, the control system and/or monitoring system may include a policy engine that may apply one or more policies. These policies may be based at least in part on characteristics of a given item of equipment or environment. With respect to control policies, a neural network can receive input of a number of environmental and task-related parameters. These parameters may include an identification of a phase break, location data from various sensors, etc. The neural network can be trained to generate an output based on these inputs, with the output representing an action or sequence of actions that the vehicle should take to travel through the phase break. During operation of one embodiment, a determination can occur by processing the inputs through the parameters of the neural network to generate a value at the output node designating that action as the desired action. This action may translate into a signal that causes the vehicle to operate. This may be accomplished via back-propagation, feed forward processes, closed loop feedback, or open loop feedback. Alternatively, rather than using backpropagation, the machine learning system of the controller may use evolution strategies techniques to tune various parameters of the artificial neural network. The controller may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the output from the various models are obtained, they may be evaluated on their performance using a determined success metric. The best model is selected, and the vehicle controller executes that plan to achieve the desired input data to mirror the predicted best outcome scenario. Additionally, the success metric may be a combination of the optimized outcomes, which may be weighed relative to each other.

The controller can use this artificial intelligence or machine learning to receive input (e.g., the location of the vehicle and/or the location of a phase break), use a model that associates locations with different operating modes to select an operating mode of the vehicle (e.g., powering loads using energy storage devices, dynamic breaking, or the like), and then provide an output (e.g., the operating mode selected using the model). The controller may receive additional input of the change in operating mode that was selected, operator input, or the like, which indicates whether the machine-selected operating mode provided a desirable outcome or not. Based on this additional input, the controller can change the model, such as by changing which operating mode would be selected when a similar or identical location or change in location is received the next time or iteration. The controller can then use the changed or updated model again to select an operating mode, receive feedback on the selected operating mode, change or update the model again, etc., in additional iterations to repeatedly improve or change the model using artificial intelligence or machine learning.

In one example, a control system is provided that can include a controller that may obtain a location of a phase break along a route to be traversed by a vehicle. The controller can monitor a location of the vehicle and determine an arrival time of the vehicle at the location of the phase break using the location of the phase break and the location of the vehicle. The system also may include a switch and/or an actuator. The switch can be proximate to a collector device of the vehicle. The actuator can move the collector device in at least one direction relative to a conductive pathway. The conductive pathway may operate to supply electrical power to the vehicle. The controller can actuate the switch, the actuator, or both the switch and the actuator, and (upon activation) can change a source of power for one or more loads for propulsion of the vehicle through the location of the phase break along the route.

The controller may control the switch and/or the actuator to receive the power from the conductive pathway to power the one or more loads of the vehicle prior to the vehicle reaching the location of the phase break. The controller can control the switch and/or the actuator to change the source of the power to one or more energy storage devices onboard the vehicle and to stop receiving the power from the conductive pathway during travel of the vehicle in the phase break. The controller can control the switch and/or the actuator to change the source of the power back to the conductive pathway after the vehicle exits the phase break.

The phase break may be a section of the route that does not have the conductive pathway. The phase break can include an interface between sections of the route having the conductive pathway conducting different phases of alternating current. The phase break may include an interface between sections of the route having the conductive pathway conducting different voltages of direct current relative to each other.

In another example, a method for controlling a vehicle is provided and can include obtaining a location of a phase break along a route to be traversed by the vehicle, obtaining a location of the vehicle, determining an arrival time of the vehicle at the location of the phase break based at least in part on the location of the phase break and the location of the vehicle, and controlling a responsive device to change a source of power for one or more loads of the vehicle for travel of the vehicle through the location of the phase break along the route.

The method also can include controlling the responsive device to receive the power from a conductive pathway extending along the route to power the one or more loads of the vehicle prior to the vehicle reaching the location of the phase break. The method may include controlling the responsive device change the source of the power to one or more energy storage devices onboard the vehicle and to stop receiving the power from the conductive pathway during travel of the vehicle in the phase break.

The method can include controlling the responsive device to change the source of the power back to the conductive pathway after the vehicle exits the phase break. The method may include monitoring for a drop in current to determine a location of a phase break and/or communicating a location of a phase break from the vehicle to another vehicle on the route. The method can include adapting the vehicle to a different direct current voltage as at least part of the change in the source of power (e.g., between two or more of a catenary, an electrified rail, a battery, capacitor, a fuel cell, etc.).

In another example, another control system is provided that may include a collector device that can be onboard a vehicle and can move relative to a conductive pathway extending along a route. The collector device may receive electric energy from the conductive pathway to power one or more loads of the vehicle during movement of the vehicle along the route. The control system can include a controller that may monitor locations of the vehicle and determine whether the vehicle is approaching a phase break of the conductive pathway. The controller may change a source of power for the one or more loads from the conductive pathway for travel of the vehicle through the phase break.

The phase break may include a section of the route that does not have the conductive pathway. The phase break can include an interface between sections of the route having the conductive pathway conducting different phases of alternating current. The phase break may include an interface between sections of the route having the conductive pathway conducting different voltages of direct current. The controller can change the source of power for the one or more loads from the conductive pathway to one or more energy storage devices onboard the vehicle. The controller can change the source of power by initiating movement of the collector device away from the conductive pathway.

As used herein, the “one or more processors” may individually or collectively, as a group, perform these operations. For example, the “one or more” processors can indicate that each processor performs each of these operations, or that each processor performs at least one, but not all, of these operations. Use of phrases such as “one or more of . . . and,” “one or more of . . . or,” “at least one of . . . and,” and “at least one of . . . or” are meant to encompass including only a single one of the items used in connection with the phrase, at least one of each one of the items used in connection with the phrase, or multiple ones of any or each of the items used in connection with the phrase. For example, “one or more of A, B, and C,” “one or more of A, B, or C,” “at least one of A, B, and C,” and “at least one of A, B, or C” each can mean (1) at least one A, (2) at least one B, (3) at least one C, (4) at least one A and at least one B, (5) at least one A, at least one B, and at least one C, (6) at least one B and at least one C, or (7) at least one A and at least one C.

This written description uses examples to disclose several embodiments of the subject matter, including the best mode, and to enable one of ordinary skill in the art to practice the embodiments of subject matter, including making and using any devices or systems and performing any incorporated methods. The patentable scope of the subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A system, comprising:
a controller configured to obtain a location of a phase break along a route to be traversed by a vehicle and configured to monitor a location of the vehicle, the controller configured to determine an arrival time of the vehicle at the location of the phase break using the location of the phase break and the location of the vehicle; and
one or both of a switch and an actuator, the switch being proximate to a collector device of the vehicle, and the actuator being configured to move the collector device in at least one direction relative to a conductive pathway, and the conductive pathway being operable to supply electrical power to the vehicle, and
the controller being configured to actuate the switch, the actuator, or both the switch and the actuator, and upon activation to change a source of power for one or more loads for propulsion of the vehicle through the location of the phase break along the route.

2. The system of claim 1, wherein the controller is configured to control the one or more of the switch or the actuator to receive the power from the conductive pathway to power the one or more loads of the vehicle prior to the vehicle reaching the location of the phase break.

3. The system of claim 2, wherein the controller is configured to control the one or more of the switch or the actuator to change the source of the power to one or more energy storage devices onboard the vehicle and to stop receiving the power from the conductive pathway during travel of the vehicle in the phase break.

4. The system of claim 3, wherein the controller is configured to control the one or more of the switch or the actuator to change the source of the power back to the conductive pathway after the vehicle exits the phase break.

5. The system of claim 1, wherein the phase break is a section of the route that does not have the conductive pathway.

6. The system of claim 1, wherein the phase break includes an interface between sections of the route having the conductive pathway conducting different phases of alternating current.

7. The system of claim 1, wherein the phase break includes an interface between sections of the route having the conductive pathway conducting different voltages of direct current relative to each other.

8. A method, comprising:
obtaining a location of a phase break along a route to be traversed by a vehicle;
obtaining a location of the vehicle;
determining an arrival time of the vehicle at the location of the phase break based at least in part on the location of the phase break and the location of the vehicle; and
controlling a responsive device to change a source of power for one or more loads of the vehicle for travel of the vehicle through the location of the phase break along the route.

9. The method of claim 8, further comprising controlling the responsive device to receive the power from a conductive pathway extending along the route to power the one or more loads of the vehicle prior to the vehicle reaching the location of the phase break.

10. The method of claim 9, further comprising controlling the responsive device change the source of the power to one or more energy storage devices onboard the vehicle and to stop receiving the power from the conductive pathway during travel of the vehicle in the phase break.

11. The method of claim 10, further comprising controlling the responsive device to change the source of the power back to the conductive pathway after the vehicle exits the phase break.

12. The method of claim 8, further comprising monitoring for a drop in current to determine a location of a phase break.

13. The method of claim 8, further comprising communicating a location of a phase break from the vehicle to another vehicle on the route.

14. The method of claim 8, further comprising adapting the vehicle to a different direct current voltage as at least part of the change in the source of power.

15. A system, comprising:
a collector device configured to be disposed onboard a vehicle and to move relative to a conductive pathway extending along a route, the collector device configured to receive electric energy from the conductive pathway to power one or more loads of the vehicle during movement of the vehicle along the route; and
a controller configured to monitor locations of the vehicle and to determine whether the vehicle is approaching a phase break of the conductive pathway, the controller configured to change a source of power for the one or more loads from the conductive pathway for travel of the vehicle through the phase break.

16. The system of claim 15, wherein the phase break includes a section of the route that does not have the conductive pathway.

17. The system of claim 15, wherein the phase break includes an interface between sections of the route having the conductive pathway conducting different phases of alternating current.

18. The system of claim 15, wherein the phase break includes an interface between sections of the route having the conductive pathway conducting different voltages of direct current.

19. The system of claim 15, wherein the controller is configured to change the source of power for the one or more loads from the conductive pathway to one or more energy storage devices onboard the vehicle.

20. The system of claim 15, wherein the controller is configured to change the source of power by initiating movement of the collector device away from the conductive pathway.
